(19) United States
(12) Patent Application Publication
(10) Pub. No.: US 2014/0117781 A1
(43) Pub. Date: May 1, 2014

(54) CONTROL APPARATUS FOR AN ELECTRICAL LOAD

(71) Applicants: Janis Kesten-Kühne, Clausthal-Zellerfeld (DE); Hans-Joachim Koch, Erlangen (DE)

(72) Inventors: Janis Kesten-Kühne, Clausthal-Zellerfeld (DE); Hans-Joachim Koch, Erlangen (DE)

(73) Assignee: BSH BOSCH UND SIEMENS, MUNICH (DE)

(21) Appl. No.: 14/003,608

(22) PCT Filed: Mar. 27, 2012
(86) PCT No.: PCT/EP12/55399

§ 371 Date: Jan. 2, 2014

(30) Foreign Application Priority Data
Mar. 31, 2011 (DE) 10 2011 006 609.8

(51) Int. Cl. H02J 3/14

(52) U.S. Cl. CPC H02J 3/14
USPC 307/130

(57) ABSTRACT

A control apparatus for controlling the power of an electrical load, in particular of an electrical domestic appliance or an assembly of an electrical domestic appliance, comprises at least one sensor for detecting a parameter of an electrical supply voltage, and a processing means for comparing a parameter which is detected by the sensor with a prespecified value, and for influencing the power of the load on the basis of the result of the comparison.

The present invention relates to a control apparatus for controlling the power of an electrical consumer, in particular an electrical domestic appliance or an assembly of an electrical domestic appliance.

Domestic refrigeration appliances conventionally have an integrated control apparatus, which controls the power of a refrigerant compressor based on the temperature measured in a storage chamber of the refrigeration appliance. The control apparatuses of other domestic appliances, for example dishwashers, washing machines or the like, essentially represent a user interface, by way of which a user can select and start a function of the machine or a program to be run by the machine. It has already been proposed that domestic appliances should be connected to external control apparatuses by way of a digital network, in order thus to allow a user to control appliances in the household remotely.

The increasing contribution of regenerative sources that are not continuously available, for example wind power and photovoltaics, to the public power supply gives rise to considerable network regulation problems. As the quantity of electrical power available from such sources cannot be forecast reliably, either power drawn from other sources must be adjusted in the short term so that the power available as a whole in the network corresponds to consumer requirements or consumer demand must be influenced in the short term to adjust it to supply. Methods for this are currently being discussed at length as part of the “smart grid” concept. All these methods assume the existence of a control unit which is able to communicate with both the generators and consumers of electrical energy and to influence the power output or consumed by them to align supply and demand for electrical power. For a smart grid to be implemented successfully, a control unit must first be provided on the power supplier side, which is able to communicate with consumers to influence their power take-up. Previously appliances that can operate as intelligent consumers in a smart grid were not available on the market. But even if suitable control units are available, smart grid-compatible appliances will only become more widespread in the field gradually as they replace old appliances, in which process the expected additional costs for the communication interfaces required with the new appliances could represent a further barrier.

There is therefore a need for a method which allows the power of an electrical consumer to be modulated according to the availability of power in the supply network in a simple manner, without requiring centralized detection of the generated and required power and elaborate digital message communication between the generators and consumers of electrical energy.

The object is achieved by a control apparatus for controlling the power of an electrical consumer, in particular an electrical domestic appliance or an assembly of an electrical domestic appliance, having at least one sensor for detecting a parameter of an electrical supply voltage and a processing means for comparing a parameter detected by the sensor with a predetermined value and for influencing the power of the consumer based on the result of this comparison.

The invention is based on the idea that imbalances in power generation and demand in an electrical supply network impact on parameters of the supply voltage, such as voltage and/or frequency, so that a control apparatus for a consumer, which is designed to monitor at least one such parameter, can identify a divergence of power supply and demand autonomously and align the power consumption of a consumer it controls accordingly.

If according to one embodiment the at least one sensor is a voltage sensor, the predetermined value is expediently defined in the form of a threshold and the processing means is set up to ascertain that first conditions for increasing the power of the consumer are present if the voltage measured by the sensor is above the threshold and/or first conditions for lowering the power are present if the measured voltage is below the threshold. Whether the increasing or lowering of the power actually takes place in the presence of the first conditions can also be made a function of second conditions. If the processing means judges the presence of the first conditions for both increasing and lowering, the threshold for lowering can expediently be different from the threshold for increasing, to avoid unnecessary switching on and off.

Orientation of the control apparatus to the network voltage in particular has the advantage that it allows geographically very precise control of the power. In an extreme instance such a control apparatus can control for example at least one of a number of jointly protected electrical consumers in a private household. If this number of consumers is in operation together, the voltage drop in their shared supply line is greater than when just one individual consumer is operating. If the control apparatus identifies this by comparing the electrical supply voltage with a suitably predetermined threshold, and thereupon ascertains that the first conditions for lowering the power are present, it can take the decision—optionally taking into account the second conditions—that the power is actually lowered. This reduces the voltage drop on the supply line and it is not only possible to reduce demand peaks in this manner but power losses are also reduced. Conversely the control apparatus can ascertain by comparing the threshold—which may be set to a different value here—whether the adjacent consumers have just been switched off and if so can ascertain that the time is favorable for increasing the power of the consumer it controls.

A major imbalance between power supply and demand also impacts on the frequency of the supply voltage. Therefore according to a second embodiment of the invention the at least one sensor can be a frequency sensor. The predetermined value can then also be a threshold, with values above and below it indicating an imbalance between power supply and demand. However in this instance the predetermined value is preferably an interval and the processing means is set up to ascertain that the necessary conditions for increasing the power of the consumer are present if the parameter detected by the sensor, i.e. the measured frequency of the supply voltage, lies within the interval and/or for lowering the power are present if the detected parameter lies outside the interval.

An increasing or lowering of the power of an electrical consumer as a function of the state of the supply network is of course only acceptable to the user of the consumer in so far as it does not have an adverse effect on the expected function of the consumer, for example the chilling of food stored in a refrigeration appliance or the prompt completion of a wash cycle. In order in particular to allow the lowering of the power without function impairment, it is helpful if the processing means is set up to identify recurring patterns in the time sequence of the monitored parameter, to forecast a future comparison result based on such an identified pattern and, if the forecast comparison result indicates that the necessary conditions for lowering the power will soon be present, to ascertain at a current time point that the necessary conditions for increasing the power are present. Such increasing of power then allows the user to chill ahead for example or to allow a selected program to run earlier than usually scheduled or more quickly for a time so that the power of the consumer can actually be reduced at the forecast time point, without this impairing its expected function.

In the simplest instance influencing the power means switching the consumer on and/or off. As switching on and off represents a significant intervention in the function of the consumer, there is a risk that the second conditions for this are present relatively infrequently; in other words although it might be desirable from the point of view of power supply and demand to influence the power of the consumer in one direction or the other, influencing does not ultimately take place, as it would affect the function of the consumer too much. If in contrast influencing the power also comprises a switch between non-vanishing power stages of the consumer, the second conditions are in practice more frequently met so the power of the consumer is actually changed if this is desirable.

In order to judge the second conditions, the control apparatus can expediently comprise at least one second sensor for detecting an internal parameter of the consumer. If the consumer is a compressor of a refrigeration appliance, the internal parameter is then expediently the temperature of a storage chamber of the refrigeration appliance.

If the consumer is set up to perform a predetermined task, for example a wash program, by the end of a predetermined time period, influencing the power can then also mean that the consumer is switched on promptly by the control apparatus, in order to complete the task before the end of the predetermined time period.

The inventive control apparatus, in particular if it is designed to take into account internal parameters of the controlled consumer when deciding about influencing the power, can be integrated in a structural unit with the controlled consumer.

It is however also possible for the processing means of the control apparatus to be accommodated at least partially in a structural unit that is separate from the consumer, in particular if said processing means are set up to control a number of consumers, possibly of different types.

The control apparatus is preferably integrated in a domestic appliance, in particular a domestic refrigeration appliance, to control it as required.

Further features and advantages of the invention will emerge from the description which follows of exemplary embodiments with reference to the accompanying figures, in which:

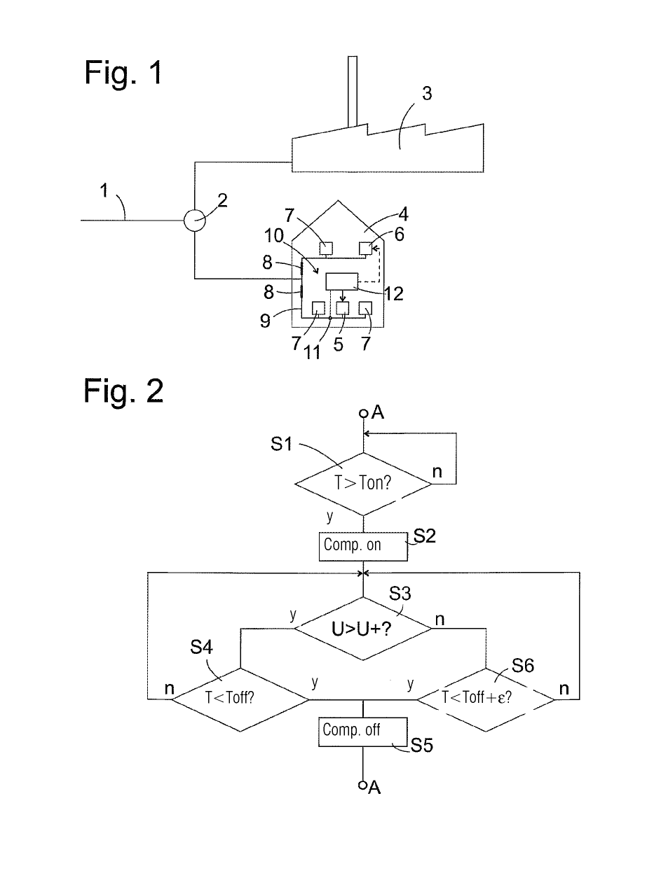

FIG. 1 shows a sketch of an electrical supply network, in which the present invention can be used;

FIG. 2 shows a flow diagram of a control method performed by an inventive control apparatus according to a first embodiment of the invention;

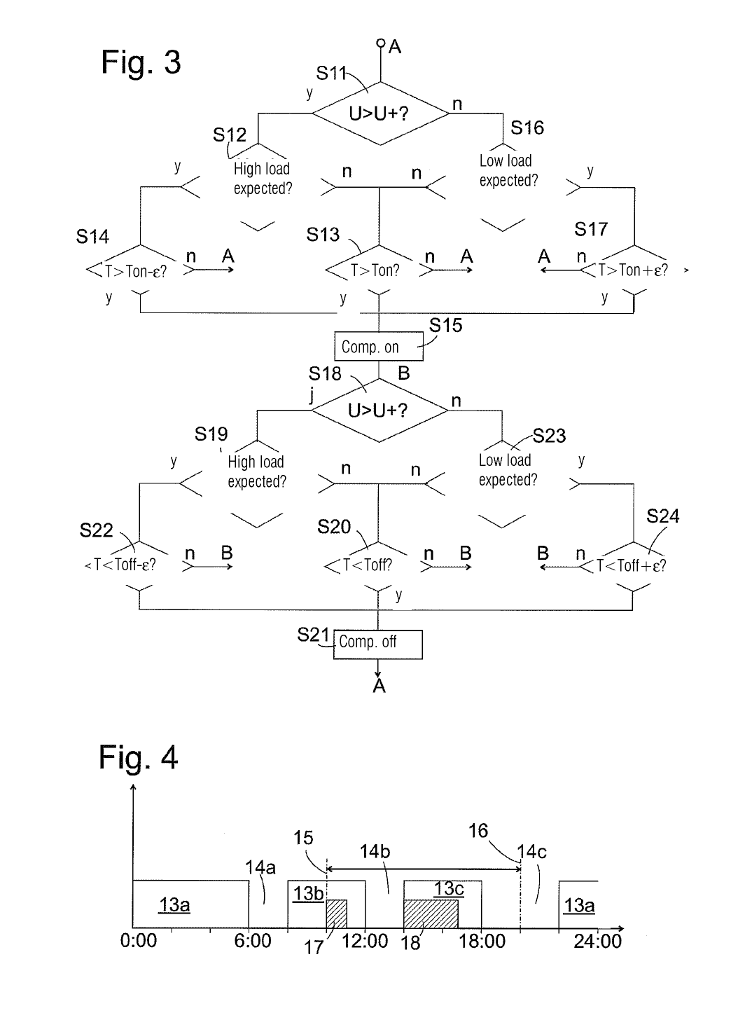

FIG. 3 shows a flow diagram according to a second embodiment of the invention; and

FIG. 4 shows the temporal relationship between the completion of a work program by an electrical domestic appliance and the power supply in the supply network according to a third embodiment of the invention.

An electrical supply network shown in FIG. 1, in which the present invention can be used, comprises generators (not shown) of electrical energy of different, random types, which supply commercial and private users 3 and 4 with electrical energy by way of a high-voltage line 1, for example of a cross-region integrated network, and transformer stations 2. Use of the invention is largely discussed in the following only with reference to the private user but application to the commercial user 3 should not pose problems for the person skilled in the art based on the following description.

The private user 4 uses a plurality of electrical consumers 5, 6, 7, in particular electrical domestic appliances such as refrigeration appliances or freezers, a dishwasher, washing machine, tumble dryer or the like. A number of said consumers are protected in each instance by way of a shared fuse 8, so that voltage fluctuations can occur on a segment 9 of the supply line, which connects the relevant consumers to their fuse 8, as a function of the power taken up by the consumers supplied by way of said segment 9. A control apparatus 10 comprises a voltage and frequency sensor 11, which is disposed on the line segment 9, to detect the network voltage and frequency present there, and a signal processor 12 connected to the sensor. The sensor 11 can be coupled galvanically or inductively to the line segment 9.

According to a first embodiment of the invention the control apparatus 10 controls a single consumer 5, to which it is assigned in a fixed manner, for example by integration in its housing.

According to a second embodiment the control apparatus 10 can be designed to control a number of consumers 5, 6. The control apparatus is then generally implemented as an autonomous structural unit, which communicates with the controlled consumers 5, 6 by way of a signaling protocol known per se, for example dBus-II, to influence their power take-up. In the diagram in FIG. 1 the consumer 6 is protected by way of a different fuse 8 from the consumer 5, so that the network voltage reaching the consumer 6 may differ slightly from that detected by the sensor 11 and, if the consumer 6 reduces its power take-up in response to a message from the control apparatus 10, this has no influence on the voltage drop in the line segment 9 supplying the consumer 5. If the reason for too low a network voltage measured by the sensor 11 is spatially removed from the private user 4, e.g. a demand peak at the commercial user 3, it is also helpful to reduce the power take-up at the consumer 6 to stabilize the network voltage.

An elementary variant of a work method performed by the control apparatus 10 according to the first embodiment is described with reference to FIG. 2. The controlled consumer 5 here is the compressor of a domestic refrigeration appliance of generally known design, in which the control apparatus 10 is integrated. It is assumed that the compressor is switched off at the start point A of the method. The control apparatus 10 is connected to a temperature sensor (not shown) to monitor the temperature T of a storage chamber of the refrigeration appliance. In step S1 the control apparatus 10 checks in the known manner whether this temperature T is above a switch-on temperature Tₒₙ that can be set by the user. If not, the step is regularly repeated. If the switch-on temperature Tₒₙ is exceeded, the compressor is switched on in step S2. In step S3 it is checked whether the network voltage U on the line 9 is above a threshold U+. If so, the electrical power supply is sufficient or of the consumers 7 sharing the line segment 9 with the consumer 5 not so many are in operation as to cause a clear voltage drop on the line 9. The control apparatus 10 then compares the temperature T with a “normal” switch-off temperature T_{off} in the following step S4. If the measured value is not below this, the method returns to step S3; otherwise the compressor is switched off again in step S5 and the method returns to the start.

If in contrast the comparison in step S3 reveals a supply voltage below the threshold U+, the temperature T is compared with an increased switch-off temperature Toff+e, which is between Toff and Ton, in step S6. As a result the compressor is switched off again earlier when the power supply is scant than if the power supply were sufficient, so the load on the network generally decreases and the power supply improves for the other consumers 7.

If the supply network in a defined geographical region is subject to heavy loading and the network voltage in said region therefore drops, this can be taken into account in a large number of controlled consumers 5, 6 in said region and if at least some of said consumers actually restrict their power take-up, the overload can be eliminated and the network voltage can be stabilized again. There is therefore little need, in the context of an extensive integrated network, to transport electrical power from remote regions with the losses this incurs into the overloaded region. If the demand restriction that can thus be achieved is not sufficient, the network frequency can be displaced, which is generally perceived to a much lesser degree in the supply network than the voltage drop. If the control apparatus responds not only to a network voltage fluctuation but also to a network frequency fluctuation, even extremely remote control apparatuses can register the fluctuation and respond thereto.

In order to take this fact into account, in one variant of the method step S3 can be replaced by a check as to whether or not the network frequency lies within a predetermined interval around its setpoint value of 50 Hz or both the network voltage and network frequency can be checked and step S6 can be performed, if at least one of the two criteria indicates an insufficient power supply.

We will look next at the instance of a control apparatus 10, which is designed to control a number of consumers 5, 6 of different, extremely random types. The consumer 5 here is again a domestic refrigeration appliance, the consumer 6 can be for example a PC, the power take-up of which can be changed by varying its clock cycle. The conditions under which the power take-up of the domestic refrigeration appliance can be reduced without functionality losses are of course different from those under which this is possible with a PC. As the function and design of the control apparatus 10 should be as independent as possible of the types and number of consumers 5, 6 controlled by it, it cannot take into account their particularities and therefore cannot generate commands to which a controlled consumer 5 or 6 could expediently respond due to an unconditional change in power take-up. The control facility 10 can only ascertain by monitoring network voltage and/or network frequency whether the necessary conditions are present, which make the switching on or off of a consumer or the switching between different power levels of the consumer expedient. If such conditions are present, the decision whether or not to actually switch on or off or to change power must remain with an internal control apparatus of the consumer 5 or 6, which interacts via the control apparatus 10. As far as the method in FIG. 2 is concerned, this means for example that a thermostat control apparatus of the refrigeration appliance performs steps S1, S2, S5 but for the decision as to whether step S4 or S6 is to be executed it uses a result of the comparison S3 signaled by the external control apparatus 10.

FIG. 3 shows a flow diagram for the control of a refrigeration appliance which can be executed as described above in total by an integrated control apparatus 10 of the refrigeration appliance 5 or in a shared manner by an external control apparatus 10 and a thermostat control apparatus of the refrigeration appliance 5. The particularity of the method in FIG. 3 is that the control apparatus 10 here is designed to monitor the power supply in the network during the course of the day and to identify times with sufficient or scant power supplies that regularly recur automatically and to provide a record thereof.

Again it is assumed that at the start point A of the method the compressor of the refrigeration appliance 5 is switched off. In step S11, as already described in relation to FIG. 2, it is judged based on the network voltage and/or network frequency detected by the sensor 11 whether or not the current power supply in the supply network is sufficient. If it is sufficient, it is checked in step S12 based on the previously provided record whether an insufficient power supply can be expected in the quite near future, in other words in a time period in which the compressor would probably still be in operation if it is switched on at the current time point. If this is not the case, the temperature T of the refrigeration appliance is compared with the normal switch-on temperature Ton in step S13 and if this normal switch-on temperature is not exceeded, the method returns to the start A. If however the check in step S12 indicates that the power supply will become scant during the probable runtime of the compressor, in step S14 the temperature T is compared with a lowered switch-on temperature Ton-ε. As a result the compressor is switched on when the refrigeration appliance is at a relatively low temperature T (step S15), at which this would not occur if the power supply were continuously sufficient. Therefore when the power supply is actually scant the refrigeration appliance is already prechilled and the compressor can remain switched off for a long time without causing the chilled goods to heat up in an undesirable manner. In other words in a time when there is sufficient supply the refrigeration appliance consumes electrical energy in advance so that it can limit its consumption when supply is scant.

If conversely it is ascertained in step S11 that the power supply is currently scant, it is checked in step S16 whether a time period with sufficient power supply is imminent. If not, chilling must take place as normal despite scant supply and the method moves on to step S13. If however a time period with sufficient power supply is imminent, it is expedient to delay the switching on of the compressor. This is done by branching to step S17, where the temperature T is compared with an increased switch-on temperature Ton+ε and the compressor is only switched on (S15) if this increased switch-on temperature is exceeded.

When the compressor is switched on, steps S3 to S6 from FIG. 2 can follow in the same way, in contrast to the diagram in FIG. 3.

In the flow diagram in FIG. 3 in contrast, when the operating state shown as B with the compressor switched on is reached, a check S18 first takes place again to determine whether the current power supply is sufficient and, if so, a check 19 to determine whether scant power is soon to be expected. If this is not the case, the compressor is switched off again over steps S20, S21 as soon as the temperature drops below the normal switch-off temperature Toff. In contrast if scant power is to be expected, in step S22 a comparison is performed with a lowered switch-off temperature Ton-ε and the compressor is switched off again only if the value is below this. This also prechills the refrigeration appliance in preparation for the imminent scant power supply so that when the scant power supply starts the compressor can be switched off for a long period. If the scant power supply starts during operation of the compressor, the method branches from step S18 to step S23. It is checked here whether a time period of better power supply can be expected again soon. If not, normal chilling operation follows with steps S20, S21. If an improved supply can be expected, a comparison takes place in step S24 with an increased switch-off temperature Toff+ε. If the value is below this, before the power supply improves the compressor is switched off, earlier than in normal operation, so that when sufficient power is available again later, the switch-on temperature Ton is reached again more quickly and the phase of sufficient supply can therefore be effectively utilized.

FIG. 4 shows a pattern of phases of sufficient and scant power supply on the supply line 9 of the private user 4, as could appear typically in the record of the control apparatus 10. Phases 13a, 13b, 13c of sufficient supply during the night, morning and afternoon are interrupted by phases 14a, 14b, 14c of high power demand in the morning, at noon and in the evening. A control apparatus 10 for controlling consumers of different types continuously registers the power supply during the course of the day and is therefore able after several days of operation to predict the periods of sufficient or scant power supply with increasing accuracy. Such a control apparatus 10 supplies the consumers 5, 6 controlled by it at regular time intervals with information that indicates whether or not the current power supply is sufficient and with details of the time remaining until the next change of state. A washing machine controlled by this control apparatus 10 is brought into operation by a user for example at a time point 15 during the course of the morning in order to complete a wash program by a time point 16 in the evening programmed by the user, said wash program comprising a prewash and main wash cycle. At time point 15 the power supply is sufficient and the information signaled by the control apparatus 10 indicates to the washing machine that it will remain so for the probable duration of the prewash cycle 17. The machine therefore starts the prewash cycle 17 immediately. The information coming from the control apparatus 10 at the end of the prewash cycle 17—during the course of phase 13b—indicates to the washing machine that the power supply is sufficient but the time remaining until the start of the next scant phase 14b is not long enough to perform the main wash cycle 18 with a continuously sufficient power supply. The washing machine therefore delays the start of the main wash cycle 18. It either starts the main wash cycle 18—as shown in FIG. 4—when the next phase 13c of sufficient power supply starts or when this is necessary at the latest, regardless of the power supply, to complete the main wash cycle 18 promptly at time point 15. The wash program is therefore completed by the time 16 desired by the user largely or completely avoiding phases 14 of scant power supply.

The mode of operation described above for the washing machine can be applied to any electrical domestic appliances, which can be programmed to complete a specific task by a time point specified by a user, for example a tumble dryer, dishwasher, breadmaker and so on.

1. A control apparatus for controlling the power of an electrical consumer, in particular an electrical domestic appliance or an assembly of an electrical domestic appliance, having at least one sensor and a processing means for comparing a parameter detected by the sensor with a predetermined value and for influencing the power of the consumer based on the result of this comparison, wherein the at least one sensor is a voltage sensor for detecting a network voltage, characterized in that the processing means is set up to identify recurring patterns in the time sequence of the network voltage, to forecast a future comparison result based on an identified pattern and, if the forecast comparison result indicates that first conditions for lowering the power are present (S12), to ascertain at a current time point (S14) that first conditions for increasing the power (S15) are present.

2. (canceled)

3. (canceled)

4. The control apparatus as claimed in claim 1, wherein the predetermined value is a threshold and the processing means is set up to ascertain that the first conditions (S3) for increasing (S2, S15) the power of the consumer are present if the network voltage detected by the sensor is above the threshold and/or that first conditions for lowering the power are present if the detected network voltage is below the threshold (U+).

5. The control apparatus as claimed in claim 1, wherein the predetermined value is an interval and the processing means is set up to ascertain that first conditions for increasing the power of the consumer are present if the parameter detected by the sensor lies within the interval and/or for lowering the power are present if the detected parameter lies outside the interval.

6. (canceled)

7. The control apparatus as claimed in claim 1, wherein influencing the power comprises switching (S2, S5, S15, S21) the consumer on and/or off.

8. The control apparatus as claimed in claim 1, wherein influencing the power comprises switching between non-vanishing power stages of the consumer.

9. The control apparatus as claimed in claim 1, wherein it comprises at least one second sensor for detecting an internal parameter (T) of the consumer and the processing means is also set up to influence the power taking into account the internal parameter (T).

10. The control apparatus as claimed in claim 9, wherein the consumer is a compressor of a refrigeration appliance and the internal parameter is the temperature (T) of a storage chamber of the refrigeration appliance.

11. The control apparatus as claimed in claim 1, wherein the consumer is set up to perform a predetermined task by the end of a predetermined time period and influencing the comprises switching the consumer on promptly before the end.

12. The control apparatus as claimed in claim 11, wherein the consumer is a dishwasher, washing machine, tumble dryer or breadmaker.

13. The control apparatus as claimed in claim 1, wherein it is integrated in a structural unit with the controlled consumer.

14. The control apparatus as claimed in claim 1, wherein the processing means are accommodated at least partially in a structural unit that is separate from the consumer.

15. A domestic appliance, in particular a domestic refrigeration appliance, characterized by a control apparatus as claimed in claim 1.
